(19) United States
(12) Patent Application Publication
(10) Pub. No.: US 2012/0082295 A1
(43) Pub. Date: Apr. 5, 2012

(54) Radiographic imaging apparatus, radiographic imaging system, image processing device, and computer-readable recording medium for storing program

(75) Inventors: Toshitaka Agano, Kanagawa (JP); Takao Kuwabara, Kanagawa (JP)

(73) Assignee: FUJIFILM Corporation, Tokyo (JP)

(21) Appl. No.: 13/200,860

(22) Filed: Oct. 4, 2011

(30) Foreign Application Priority Data
Oct. 5, 2010 (JP) 2010-226009

(51) Int. Cl. G01N 23/04

(52) U.S. Cl. 378/62

(57) ABSTRACT

There is provided a radiographic imaging apparatus including: a radiation source configured to separately emit high energy radiation and low energy radiation by virtue of inverse Compton scattering; an imaging section configured to separately capture a radiographic image with the high energy radiation and a radiographic image with the low energy radiation that are emitted from the radiation source onto a same site to be imaged; and an image processing section configured to perform image processing in which an energy subtraction image is produced by performing a weighting calculation such that the radiographic image captured with the high energy radiation and the radiographic image captured with the low energy radiation by the imaging section are weighted for corresponding pixels according to a distance from a center of the radiation emitted from the radiation source.

### CROSS-REFERENCE TO RELATED APPLICATION

This application is based on and claims priority under 35 USC 119 from Japanese Patent Application No. 2010-226009 filed on Oct. 5, 2010, the disclosure of which is incorporated by reference herein.

### BACKGROUND

1. Technical Field

The present invention relates to radiographic imaging apparatus, a radiographic imaging system, image processing device, and computer-readable recording medium for a storing program.

2. Related Art

Radiation detectors such as a Flat Panel Detector (FPD) have been put into practice in recent years. The FPD includes a Thin Film Transistor (TFT) active matrix substrate, and a radiation-sensitive layer disposed on this substrate, and is able to directly convert emitted radiation such as X-rays into digital data. Compared to a conventionally used radiographic imaging apparatus using X-ray film and an imaging plate, radiographic imaging apparatus incorporating this radiation detector has a merit such that an image can instantly be checked, or that radioscopic imaging (dynamic imaging) in which radiographic images are captured successively can be performed as well.

Various types have been proposed for the above-described radiographic image detector. For example, there is known an indirect-conversion-type radiographic image detector that once converts irradiated radiation into light at a scintillator layer such as Caesium Iodide (CsI): Thallium (Tl), and Gadolinium Sulfated Substance (GOS) (i.e., Sulfated Gadolinium (Gd2O2S): Terbium (Tb)), and this converted light is then itself converted into electric charges by a sensor section such as a photodiode, and these electric charges are accumulated. The radiographic imaging apparatus reads out electric charges accumulated in the radiation detector as electric signals, uses an amplifier to amplify the electric signals, and then uses an Analog/Digital (Analog/Digital) conversion section to convert the electric signals into digital data.

A known technique of radiographic imaging includes taking radiographic images of the same site on a subject at different tube voltages, and performing image processing in which radiographic images thus obtained are weighted to calculate the difference between them (hereinafter referred to as “a subtraction image processing”), thereby obtaining a radiographic image in which either one of hard tissues such as bones and soft tissues is emphasized and the other is removed (hereinafter referred to as “an energy subtraction image”), (for example, see Japanese Patent Application Laid-Open (JP-A) No. 2-275582).

To obtain a sharp energy subtraction image, it is preferable that radiographic imaging is carried out using radiation with similar energy characteristics.

However, X-ray tubes used as conventional radiation sources generate a variety of radiation with different energy peaks when radiation is generated by the application of different tube voltages.

To overcome the foregoing drawback, JP-A No. 2002-162371 discloses a technique in which a laser beam collides with an accelerated electron beam, thus generating radiation that has similar energy characteristics by virtue of inverse Compton scattering.

However, radiation generated at the point where the laser and electron beams collide is dependent on the angle of the radiation relative to the direction of travel of the electron beam, such that as this angle increases, the energy of the radiation decreases.

This results in the problem that even when a subtraction image processing is performed as is conventional for a radiographic image captured by emitting radiation of different energies onto the same site from a radiation source using inverse Compton scattering, no satisfactory energy subtraction image can be obtained.

### SUMMARY OF THE INVENTION

The invention has been proposed in view of the foregoing problem and it is an object of the invention to provide radiographic imaging apparatus, a radiographic imaging system, image processing device, and computer-readable recording medium for storing programs, with which satisfactory energy subtraction images can be obtained even where a radiation source that emits radiation by virtue of inverse Compton scattering is used.

In order to achieve the foregoing object, a first aspect of the present invention provides a radiographic imaging apparatus including:

a radiation source configured to separately emit high energy radiation and low energy radiation by virtue of inverse Compton scattering;

an imaging section configured to separately capture a radiographic image with the high energy radiation and a radiographic image with the low energy radiation that are emitted from the radiation source onto a same site to be imaged; and

an image processing section configured to perform image processing in which an energy subtraction image is produced by performing a weighting calculation such that the radiographic image captured with the high energy radiation and the radiographic image captured with the low energy radiation by the imaging section are weighted for corresponding pixels according to a distance from a center of the radiation emitted from the radiation source.

According to the first aspect of the invention, high energy radiation and low energy radiation are emitted separately from the radiation source by virtue of inverse Compton scattering, and an imaging section captures a radiographic image formed by the high energy radiation and a radiographic image captured with the low energy radiation, which are emitted from the radiation source onto the same site to be imaged.

Then, in the invention, an image processing section produces an energy subtraction image by performing a weighting calculation such that a radiographic image formed by the high energy radiation and a radiographic image formed by the low energy radiation captured by an imaging section are weighted for the corresponding pixels according to the distance from the center of the radiation emitted from the radiation source.

According to a first aspect of the invention, as described above, the energy subtraction image is produced by performing the weighting calculation such that the radiographic image captured with high energy radiation and the radiographic image captured with low energy radiation are weighted for the corresponding pixels according to the distance from the center of the radiation emitted from the radiation source. Accordingly, even when a radiation source that emits radiation by virtue of inverse Compton scattering is used, satisfactory energy subtraction images can be obtained.

Additionally, a second aspect of the present invention provides the radiographic imaging apparatus according to the first aspect, wherein when producing a soft part image as the energy subtraction image, the image processing section performs the weighting calculation such that weighting of the radiographic image captured with the high energy radiation is reduced relative to the radiographic image captured with the low energy radiation as the distance from the center increases, and subtracts the radiographic image captured with the low energy radiation from the radiographic image captured with the high energy radiation.

In addition, a third aspect of the present invention provides the radiographic imaging apparatus according to the first aspect, wherein when producing a hard part image as the energy subtraction image, the image processing section performs the weighting calculation such that weighting of the radiographic image captured with the high energy radiation is reduced relative to the radiographic image captured with the low energy radiation as the distance from the center increases, and subtracts the radiographic image captured with the high energy radiation from the radiographic image captured with the low energy radiation.

Additionally, a fourth aspect of the present invention provides the radiographic imaging apparatus according to the first aspect, further including a moving section configured to move the radiation source relative to the site to be imaged,

wherein the imaging section separately captures the radiographic image with the high energy radiation and the radiographic image with the low energy radiation while the moving section changes an emission range of the radiation emitted from the radiation source to the site to be imaged, and

wherein the image processing section separately performs the image processing for each of the radiographic image captured with the high energy radiation and the radiographic image captured with low energy radiation in the corresponding radiation ranges by the imaging section, and combines the energy subtraction images produced by each of the image processing.

In order to achieve the foregoing object, a fifth aspect of the present invention provides a radiographic imaging system including:

a radiation source configured to separately emit high energy radiation and low energy radiation by virtue of inverse Compton scattering;

an imaging section configured to separately capture a radiographic image with the high energy radiation and a radiographic image with the low energy radiation that are emitted from the radiation source onto a same site to be imaged; and

an image processing section configured to perform image processing in which an energy subtraction image is produced by performing a weighting calculation such that the radiographic image captured with the high energy radiation and the radiographic image captured with the low energy radiation by the imaging section are weighted for corresponding pixels according to a distance from a center of the radiation emitted from the radiation source.

According to the invention, this aspect operates in the same manner as the first aspect, a satisfactory energy subtraction image can be obtained even when a radiation source that emits radiation by virtue of inverse Compton scattering is used.

Further, a sixth aspect of the present invention provides an image processing device including:

a capturing section configured to capture a radiographic image with high energy radiation and a radiographic image with low energy radiation by irradiating a same site to be imaged using a radiation source configured to separately emit high energy radiation and low energy radiation by virtue of inverse Compton scattering; and

an image processing section configured to perform image processing in which an energy subtraction image is produced by performing a weighting calculation such that the radiographic image captured with the high energy radiation and the radiographic image captured with the low energy radiation that are obtained by the capturing section are weighted for corresponding pixels according to a distance from a center of the radiation emitted from the radiation source.

According to the invention, this aspect operates in the same manner as the first aspect, a satisfactory energy subtraction image can be obtained even when a radiation source that emits radiation by virtue of inverse Compton scattering is used.

Further, a seventh aspect of the present invention provides a computer-readable recording medium for storing a program to cause a computer to function as an image processing section configured to perform image processing in which an energy subtraction image is produced by performing a weighting calculation such that a radiographic image captured with high energy radiation and a radiographic image captured with low energy radiation by irradiating a same site to be imaged using a radiation source configured to separately emit high energy radiation and low energy radiation by virtue of inverse Compton scattering are weighted for corresponding pixels according to a distance from a center of the radiation emitted from the radiation source.

Accordingly, since the program stored in the computer-readable storage medium can cause the computer to operate in the same manner as in the first aspect, a satisfactory energy subtraction image can be obtained even when a radiation source that emits radiation by virtue of inverse Compton scattering is used.

The invention has the advantage that even when a radiation source that emits radiation by virtue of inverse Compton scattering is used, a satisfactory energy subtraction image can be obtained.

### BRIEF DESCRIPTION OF THE DRAWINGS

Exemplary embodiments of the present invention will be described in detail based on the following figures, wherein:

FIG. 1 is a view showing the configuration of a radiographic imaging system according to one embodiment;

FIG. 2 is a perspective view of the configuration of an imaging stand according to the present embodiment;

FIG. 3 is a view of the configuration of a radiation source according to the present embodiment;

FIG. 4 is a diagram in which changes in energy of X-rays with the distance from the center according to the present embodiment are represented by the degree of decrease in energy from the center;

FIG. 5 is a diagram showing the detailed configuration of the radiographic imaging system according to the present embodiment;

FIG. 6 is a flowchart illustrating a procedure for an imaging control processing program according to the present embodiment; and

FIG. 7 is a graph showing energy changes with the distance from the center of high energy X-rays and low energy X-rays.

### DETAILED DESCRIPTION OF THE INVENTION

An exemplary embodiment for carrying out the invention will be described in detail with reference to the accompanying drawings. The description below focuses on a radiographic imaging system (hereinafter referred to as “imaging system”) for taking a radiographic image by emitting X-rays as radiation.

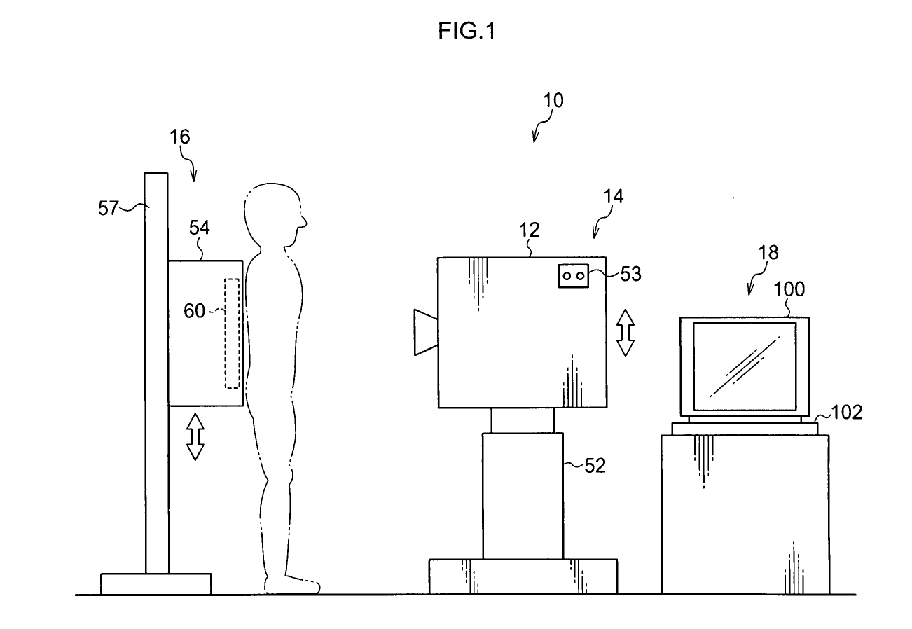

FIG. 1 shows an example of the configuration of an imaging system 10 according to the embodiment.

The imaging system 10 includes: a radiation generator 14, which has a radiation source 12 from which X-rays in a radiation quantity corresponding to a radiation exposure condition are emitted to a patient; an imaging stand 16 (serving as an imaging section), which incorporates a radiation detector 60 for outputting an electric signal indicating a radiographic image shown by X-rays passed through a to-be-imaged-site of a patient and emitted to a detecting area, and captures a radiographic image; and a console 18, which controls the imaging stand 16 and radiation generator 14.

At the imaging stand 16 taking a radiographic image is carried out in a standing posture. A space in front of the imaging stand 16 is an imaging place where a radiograph of a patient is captured in a standing posture.

In the radiation generator 14, the radiation source 12 is supported by a support base 52. The support base 52 has a drive source for vertically moving the radiation source 12. The radiation generator 14 is provided with an operating panel 53 for instructions to vertically move the radiation source 12.

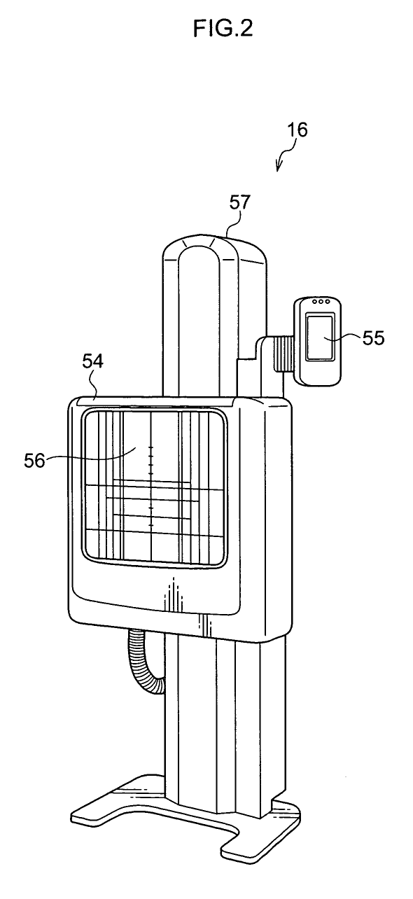

FIG. 2 is a perspective view of the configuration of the imaging stand 16 according to the present embodiment.

The imaging stand 16 includes a support post 57 by which the imaging section 54 is supported. The support post 57 includes a drive source for vertically moving the imaging section 54, and is provided with an operating panel 55 for instructions to vertically move the imaging section 54. The imaging section 54 incorporates the radiation detector 60 mentioned above. A surface corresponding to the radiation detector 60 serves as an imaging surface 56.

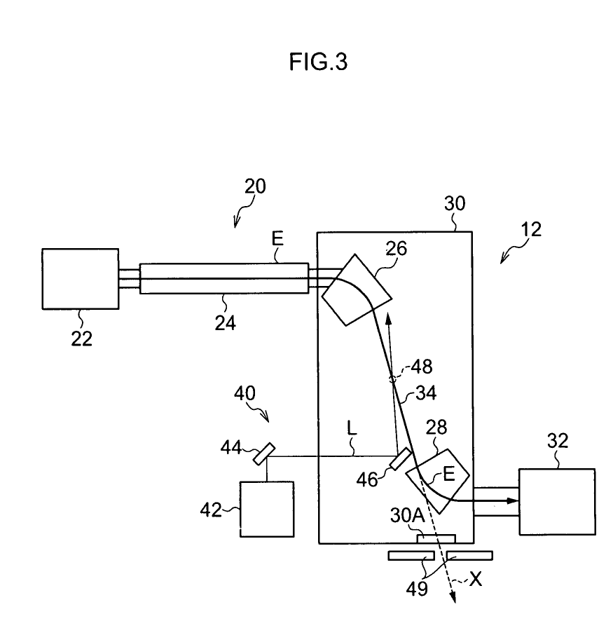

FIG. 3 is a view showing the configuration of the radiation source 12 according to the present embodiment.

The radiation source 12 includes an electron beam generator 20 and a laser beam generator 40, and causes an electron beam E and a laser beam L to collide with each other to bring about inverse Compton scattering, thereby generating X-rays as radiation.

The electronic beam generator 20 includes an electron gun 22, linear accelerating pipe 24, first polarization magnet 26, second polarization magnet 28, vacuum container 30, and electronic beam dump 32.

The linear accelerating pipe 24 is supplied with microwaves of predetermined frequency (e.g., 11.424 GHz) by a high frequency power source, not shown, thereby accelerating an electron beam E that has entered.

The electron gun 22 is a device for generating an electron beam. Specifically, it generates a pulse-like electron beam in synchronization with the cycles of microwaves supplied to the linear accelerating pipe 24. The electron beam E generated by the electron gun 22 is made to enter the linear accelerating pipe 24, and is accelerated within this pipe 24.

The electron beam E passed through the linear accelerating pipe 24 is made to enter the first polarization magnet 26. The first polarization magnet 26 bends the path 34 of the entered electron beam E by means of an electric field and then passes this electron beam along a predetermined straight path 34 through the vacuum container 30. The electron beam E passing along the straight track 34 through the vacuum container 30 is made to enter the second polarization magnet 28. The second polarization magnet 28 bends the track of the electron beam E by means of an electric field, and guides this beam to the electron beam dump 32.

The electron beam dump 32 captures the electron beam E passing along the straight track 34, thereby preventing the electron beam E from leaking.

On the other hand, the laser beam generator 40 includes a laser device 42 and laser reflecting mirrors 44 and 46.

The laser beam generator 42 generates a pulse-like laser beam L. The laser beam L generated by the laser beam generator 42 enters the laser reflecting mirrors 44 and 46 in that order and is guided so as to intersect the straight track 34 in the vacuum container 30.

At an intersection 48 where the straight orbit 34 meets the laser beam L, the electron beam E and the laser beam L collide with each other to bring about inverse Compton scattering, thereby generating X-rays

X-rays capturing window 30A is formed in the vacuum container 30 in the direction of the straight track 34. This window is made of a metal highly transparent to X-rays, such as beryllium, or another material highly transparent to X-rays, such as plastic or glass. The X-rays generated at the intersection 48 are made to exit from the X-ray capturing window 30A, and are emitted to the imaging stand 16 shown in FIG. 1.

The energy of X-rays generated by inverse Compton scattering is proportional to the square of the energy of an electron beam E and inversely proportional to the wavelength of a laser beam L.

The radiation source 12 according to the present embodiment is able to change the wavelength of a laser beam L generated by the laser beam generator 40, thereby can change the energy of X-rays generated by inverse Compton scattering.

The energy distribution of X-rays generated by inverse Compton scattering is dependent on the angle of X-rays relative to the direction of travel of an electron beam at the time of a collision between the electron beam E and laser beam L.

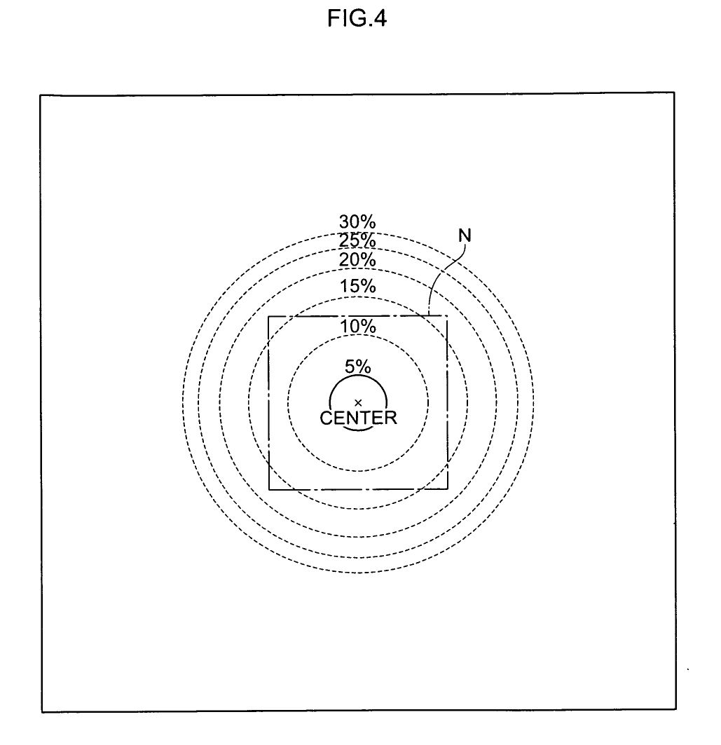

FIG. 4 is a diagram in which X-rays energy change with a distance from the center of an electron beam in its direction of travel at the time of a collision between an electron beam E and a laser beam L is represented by an energy decrease percentage from the center.

As shown in FIG. 4, the energy of X-rays generated by inverse Compton scattering spreads concentrically from the center of an electron beam E in its direction of travel at the time of collision with a laser beam L. The energy is highest at the center and becomes lower toward extremities. Specifically, as the angle of X-rays relative to the direction of travel of an electron beam increases at the time of a collision between an electron beam E and a laser beam L, the energy of the X-rays decrease.

In the radiation source 12 according to the present embodiment, a collimator 49 for limiting X-rays emission range is provided near an emission port for X-rays that are emitted to the imaging stand 16. As shown in FIG. 4, using the collimator 49, the radiation source 12 limits the X-ray emission range to a rectangular area N within the range where at the time of a collision between an electron beam E and a laser beam L, the energy of the X-rays decreases by 20 to 30% in the direction of travel of the electron beam.

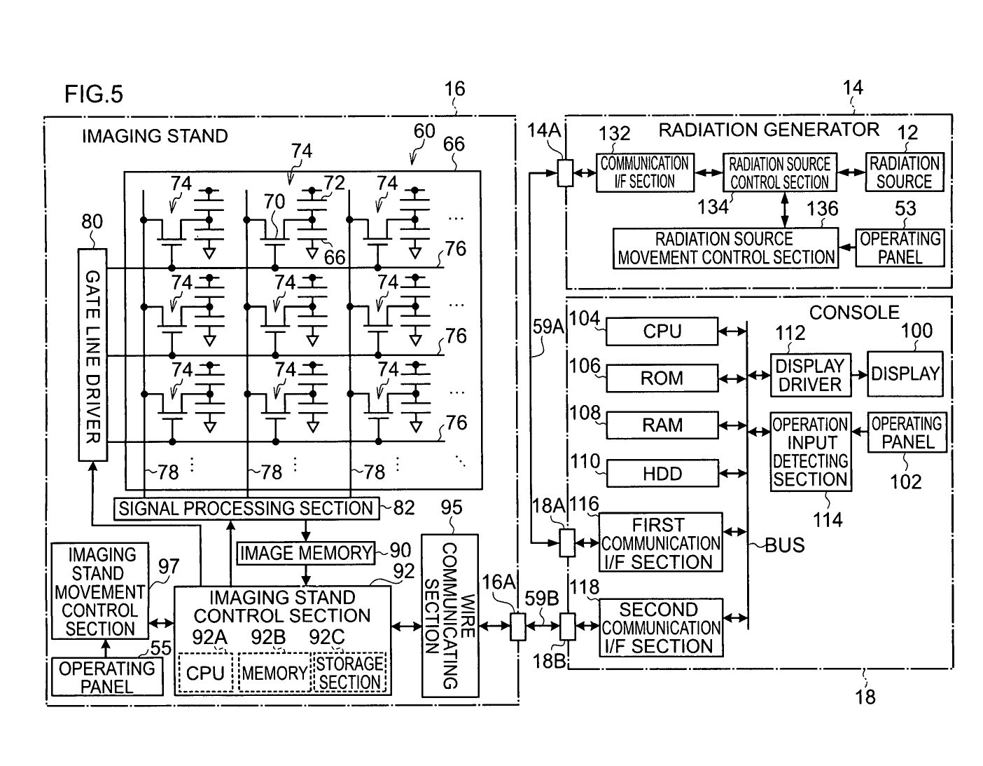

FIG. 5 is a block diagram showing the configuration of the main part of an electric system for the imaging system 10 according to the first embodiment.

As shown in FIG. 5, the radiation generator 14 is provided with a connection terminal 14A for communication with the console 18. The imaging stand 16 is provided with a connection terminal 16A for communication with the console 18. The console 18 is provided with connection terminals 18A and 18B for communication with the radiation generator 14 and imaging stand 16 respectively. The connection terminals 14A and 18A of the radiation generator 14 and console 18, respectively, are connected by a communication cable 59A. The connection terminals 16A and 18B of the imaging stand 16 and console 18, respectively, are connected by a communication cable 59B.

The radiation detector 60 incorporated in the imaging stand 16 is composed by forming a photoelectric conversion layer, which absorbs X-rays and converts them into an electric charge, over a TFT active substrate 66. The photoelectric conversion layer is formed from, for example, an amorphous selenium (a-Se) containing selenium as its main constituent (e.g., 50% or more content). When X-rays are irradiated to this substrate 66, an electric charge (an electron-hole pair) is generated within the photoelectric conversion layer such that the amount of electric charge corresponds to the amount of radiation emitted. Thereby the photoelectric conversion layer converts the emitted X-rays into an electric charge. The radiation detector 60 may indirectly convert X-rays into an electric charge by use of a fluorescent material and photoelectric conversion element (photodiode) instead of X-rays-to-electric-charge conversion material such as amorphous selenium which directly coverts X-rays into an electric charge. Examples of well-known fluorescent materials include a gadolinium sulfated substance (GOS) and caesium Iodide (CsI). In this case, X-rays are converted to light by a fluorescent material, and the light is converted to an electric charge by the photodiode of a photoelectric conversion element.

A large number of pixel portions 74 are arranged on a TFT active matrix substrate 66 in the form of a matrix (in FIG. 5, a photoelectric conversion layer corresponding to each pixel portion 74 is schematically shown as a photoelectric converting portion 72). Each pixel portion 74 includes: an accumulating capacitor 68 for accumulating electric charges generated in the photoelectric conversion layer, and a TFT 70 for reading electric charges accumulated in the accumulating capacitor 68. Electric charges generated in the photoelectric conversion layer as a result of emitting X-rays to the imaging stand 16 are accumulated in the accumulation capacitor 68 of each pixel portion 74. Thus, the image information from X-rays emitted to the imaging stand 16 is converted into charge information and held in a radiation detector 60.

Additionally, the TFT active matrix substrate 66 is provided with: gate wires 76, extended in fixed directions (i.e., in rows), for turning on/off the TFTs 70 of the corresponding pixel portions 74; and data wires 78, extended in directions perpendicular to the gate wires 76 (i.e., in columns), for reading accumulated charges from accumulating capacitors 68 via the corresponding TFTs 70 turned on. Each gate wire 76 is connected to a gate line driver 80, and each data wire 78 is connected to a signal processing section 82. When electric charges are accumulated in the accumulating capacitor 68 of each pixel portion 74, TFTs 70 of the corresponding pixel portion 74 are sequentially turned on in each row by signals supplied from the gate line driver 80 via the corresponding gate wires 76. Electric charges accumulated in the accumulating capacitor of each pixel portion 74, the TFT 70 of which has been turned on, are transmitted to the corresponding data wire 78 and input to the signal processing section 82 as an analog electric signal. Accordingly, electric charges accumulated in the accumulating capacities 68 of the corresponding pixel portions 74 are sequentially read in each column.

The signal processing section 82 includes an amplifier and a sample hold circuit, not shown, which are provided for each of the data wires 78. A charge signal transmitted to each data wire 78 is held in the sample hold circuit after being amplified by the amplifier. Additionally, a multiplexer and an Analog/Digital (A/D) converter are sequentially connected to the output side of the sample hold circuit. Electric signals held by the corresponding sample hold circuits are sequentially (serially) input to the multiplexer and converted into digital image data by the A/D converter.

Connected to the signal processing section 82 is an image memory 90, in which image data output from the A/D converter of the signal processing section 82 are stored in sequence. The image memory 90 has storage capacitor for a predetermined number of sheets. Each time a radiographic image is captured, image data captured by the imaging are sequentially stored in the image memory 90.

The image memory 90 is connected to an imaging stand control section 92 for controlling the operation of the entire imaging stand 16. The imaging stand control section 92 includes a microcomputer, which includes a Central Processing Unit (CPU) (serving as an image processing section) 92A, a memory 92B having a Read Only Memory (ROM) and a Random Access Memory (RAM), and a nonvolatile storage section 92C formed from a Hard Disk Drive (HDD), flash memory, or the like.

A wire communicating section 95 is connected to this imaging stand control section 92. The wire communicating section 95 is connected to a connection terminal 16A, and controls transmission of a variety of information between the connection terminal 16A and the console 18 via the communication cable 59B. The imaging stand control section 92 stores a radiation exposure condition (described below) received from the console 18 via the wire communicating section 95, and initiates reading of electric charges based on the radiation exposure condition.

Also connected to the imaging stand control section 92 is an imaging stand movement control section 97 for controlling vertical movement of the imaging section 54 by controlling the supply of power to the drive source provided in the imaging stand 16.

The imaging stand movement control section 97 vertically moves the imaging section 54 according to operation of the operating panel 55. A doctor (surgeon) or a technician (radiographer) may operate the operating panel 55, thereby adjusting the vertical position of the imaging section 54 according to the height of a patient or site to be imaged.

The imaging stand control section 92 determines the vertical position of the imaging section 54 based on the operating state of the drive source provided in the imaging stand 16, and informs the console 18 of the vertical position of the imaging section 54.

On the other hand, the console 18 (serving as an image processing section) is composed as a computer server. The console 18 includes: a display 100 for displaying an operating menu and recorded radiographic images, etc; and an operating panel 102, including keys, for inputting a variety of information and operating instructions.

The console 18 according to the present embodiment includes: a CPU 104 for controlling the operation of the entire apparatus; a ROM 106 for storing various programs including a control program; a RAM 108 for temporarily storing various data; an HDD 110 for storing and holding various data; a display driver 112 for controlling the display of various information on the display 100; and an operation input detecting section 114 for detecting the operating state of the operating panel 102.

Additionally, the console 18 includes: a first communication Interface (I/F) section 116 for transmitting/receiving a variety of information, such as radiation exposure conditions (described below), to/from the radiation generator 14 via the connection terminal 18A and communication cable 59A; and a second communication Interface (I/F) section 118 for transmitting/receiving various information, such as radiation exposure conditions and image data, to/from the imaging stand 16 via the connection terminal 18B and communication cable 59B.

The CPU 104, ROM 106, RAM 108, HDD 110, display driver 112, operation input detecting section 114, first communication I/F section 116, and second communication interface section 118 are mutually connected via a system BUS. This enables the CPU 104 to access the ROM 106, RAM 108, and HDD 110. This also enables the CPU 104 to control the display of a variety of information on the display 100 via the display driver 112, to control transmission/reception of a variety of information to/from the radiation generator 14 via the first communication I/F section 116, and to control transmission/reception of a variety of information to/from the imaging stand 16 via the second interface section 118. In addition, the CPU 104 is able to determine the operating state of the operating panel 102 brought by a user via the operation input detecting section 114.

On the other hand, the radiation generator 14 includes: the radiation source 12 mentioned above; a communication I/F section 132 for transmitting/receiving various information, such as a radiation exposure condition, to/from the console 18; a radiation source control section 134 for controlling the radiation source 12 based on radiation exposure condition received; and a radiation source movement control section 136 for controlling vertical movement of the radiation source 12 by controlling supply of power to the drive source provided in the support base 52.

The radiation source control section 134 is also realized by a microcomputer, and stores the radiation exposure condition received and information about posture. The radiation exposure condition received from the console 18 includes information about the energy of X-rays to be emitted and the length of time that X-rays are emitted. Upon being instructed to start radiation exposure, the radiation source control section 134 emits X-rays from the radiation source 12 based on the radiation exposure condition received.

The radiation source control section 136 vertically moves the radiation source 12 according to operation of the operating panel 53. A doctor or a technician may alter the X-ray emission range by adjusting the vertical position of the radiation source 12 with the operating panel 53. The X-ray emission range may be checked by an operator, for example, by providing an imaging camera near the radiation source 12, imaging a site to be imaged with X-rays, and showing the site thus imaged on the display 100 of the console 18. Alternatively, a lamp that emits visible light may be provided near the radiation source 12, a to-be-imaged site of the body of a subject is irradiated, and thereby an operator may check the X-ray emission range.

The radiation source control section 134 determines the vertical position of the radiation source 12 based on the operating state of the drive source provided in the support base 52, and informs the console 18 of the vertical position of the radiation source 12.

The operation of the present embodiment will now be described.

For example, to obtain an energy subtraction image of a chest region of a patient, a doctor or technician adjusts the height of the imaging section 54 with the operating panel 55 so that the center of the imaging surface 56 of the imaging section 54 corresponds to the patient's chest region, as shown in FIG. 1. The imaging stand 16 informs the console 18 of the adjusted vertical position of the imaging section 54. Additionally, a doctor or technician adjusts the height of the radiation source 12 with the operating panel 53 so that X-rays are irradiated around the region of the patient's chest. The radiation generator 14 informs the console 18 of the adjusted vertical position of the radiation source 12.

The console 18 stores emission range information in the HDD 110 in advance. The emission range information indicates the relations between the vertical positions of the imaging section 54 and radiation source 12, the X-ray emission range within the imaging surface 56 of the imaging section 54, and the central position where X-rays of the highest energy are emitted within the emission range in the direction of travel of an electron beam E at the time of a collision with a laser beam L. This emission range information may be stored as a lookup table in which the X-ray emission range within the imaging surface 56 and the central position where X-rays of the highest energy are emitted are associated with each other for the respective vertical heights of the imaging section 54 and radiation source 12. Alternatively, a calculation formula may be used, from which the X-ray emission range within the imaging surface 56 and the central position where X-rays of the highest energy are emitted are calculated for the respective vertical heights of the imaging section 54 and radiation source 12.

Based on the emission range information stored in the HDD 110, the console 18 is able to specify, from the vertical positions of the imaging section 54 and radiation source 12 informed by the imaging stand 16 and radiation generator 14 respectively, the X-ray emission range within the imaging surface 56 of the imaging section 54 and the central position of the X-rays to be emitted.

A doctor or technician uses the operating panel 102 of the console 18 to provide for a predetermined imaging instruction to obtain an energy subtraction image.

When the operating panel 102 is set to provide the predetermined imaging operation, the console 18 performs an imaging control processing in which the imaging stand 16 and radiation generator 14 are controlled and the same site of a subject is imaged plural times (in this case, twice) to form energy subtraction images at different energies.

The X-ray energy level and emission period for each act of imaging may be specified with the operating panel 102 by a doctor or technician. Alternatively, the X-ray energy level and emission period that are appropriate for a site to be imaged may be stored in the HDD 110 in advance as information about the imaging condition for each site to be imaged, and the level of X-ray energy for the site to be imaged may be obtained from this information.

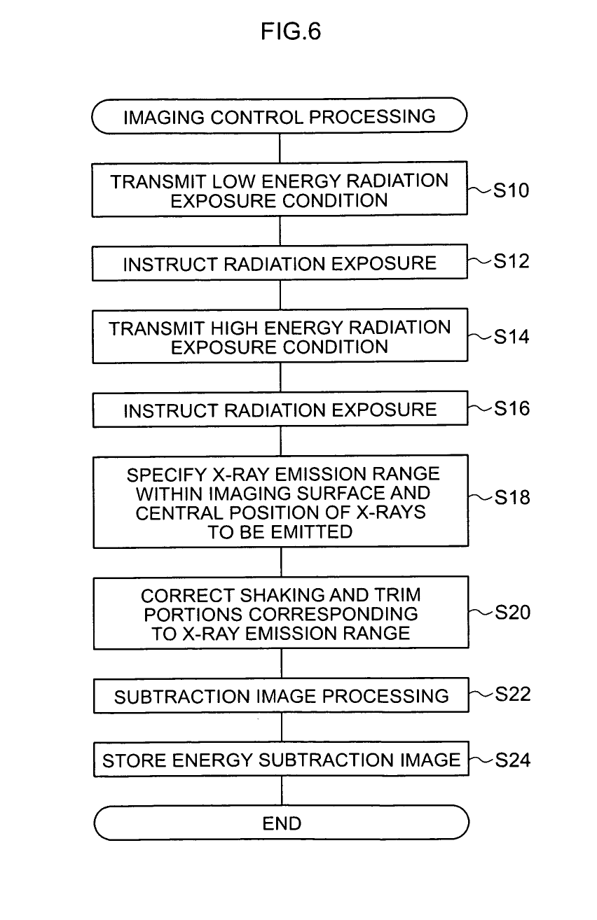

FIG. 6 shows a flowchart illustrating a procedure for an imaging control processing program performed by the CPU 104 of the console 18. This program is stored in a predetermined area of the HDD 110 in advance.

In step S10 in FIG. 6, a radiation exposure condition for imaging by first emitting

X-rays of low energy is transmitted to the radiation generator 14 and the imaging stand 16.

The radiation generator 14 and imaging stand 16 store the transmitted radiation exposure condition.

Subsequently, in step S12, information for giving an instruction to initiate radiation exposure is transmitted to the radiation generator 14 and the imaging stand 16.

Consequently, the radiation source 12 generates and emits X-rays with an energy level and an emission period appropriate to the radiation exposure condition received from the console 18.

When the emission period specified by the radiation exposure condition has elapsed after reception of the information for giving an instruction to initiate radiation exposure, the imaging stand control section 92 of the imaging stand 16 controls the gate line driver 80 such that ON-signals are output from the gate line driver 80 to the gate wires 76 sequentially one line at a time, and the TFTs 70 connected to the corresponding gate wires 76 are turned on sequentially one line at a time.

In the radiation detector 60 (serving as an imaging section), when the TFTs 70 connected to the corresponding gate wires 76 are turned on sequentially one line at a time, electric charges accumulated in the corresponding accumulating capacitors 68 flow into the corresponding data wires 78 sequentially one line at a time as electric signals. The electric signals that have flowed into the corresponding data wires 78 are converted into digital image data by the signal processing section 82, and these data are stored in the image memory 90.

Next, in step S14, a radiation exposure condition for imaging by subsequently emitting high energy X-rays is transmitted to the radiation generator 14 and the imaging stand 16.

The radiation generator 14 and imaging stand 16 store the radiation exposure condition transmitted.

Subsequently, in step S16, information for giving an instruction to initiate radiation exposure is transmitted to the radiation generator 14 and the imaging stand 16.

Consequently, as in the case described above, X-rays are generated and emitted by the radiation source 12, electric charges are read from the corresponding pixel portions 74 of the radiation detector 60 in the imaging stand 16, and digital image data are stored in the image memory 90.

The imaging stand control section 92 transmits the image information stored in the image memory 90 to the console 18 after finishing the imaging.

Subsequently, in step S18, based on emission range information stored in the HDD 110, the X-ray emission range within the imaging surface 56 of the imaging section 54 and the central position of X-rays to be emitted are specified for the vertical positions of the imaging section 54 and radiation source 12 obtained from the imaging stand 16 and radiation generator 14 respectively.

Next, in step S20, image processing to perform various kinds of correction, such as shading correction and the like, is applied to the variety of image information received as a result of the emission of high and low energy X-rays and the image of a portion corresponding to the X-ray emission range is trimmed. The image information resulting from this image processing is stored in the HDD 110.

Next, in step S22, a subtraction image processing is performed for the image information stored in the HDD 110 that was imaged with high and low energy X-rays.

The subtraction image processing according to the present embodiment will now be described.

For example, to obtain a soft-part image of soft tissue, image processing is performed such that a weighting addition as expressed below by equation (1) is performed for pixels corresponding to a radiographic image captured with high energy X-rays and pixels corresponding to a radiographic image captured with low energy X-rays.

N=Ka×H−Kb×L+Kc (1)

Here, Ka, Kb, and Kc each represent coefficients of energy subtraction,
H represents the pixel value of a radiographic image captured with high energy X-rays,
L represents the pixel value of a radiographic image captured with low energy X-rays, and
N represents the pixel value of a soft-part image.

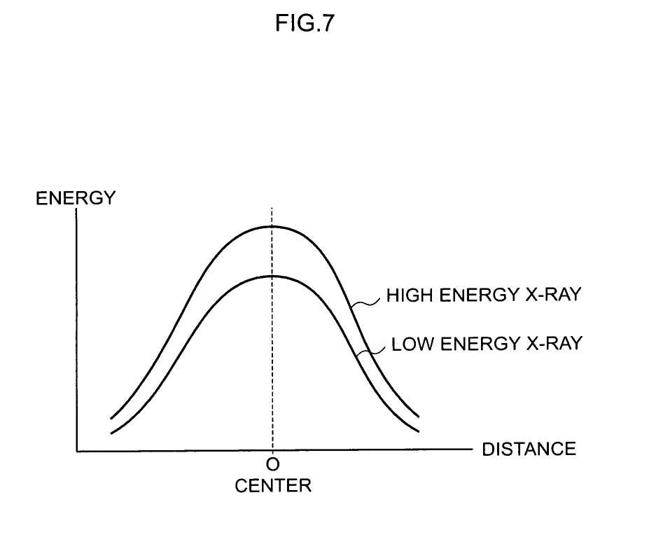

As described above, X-rays generated by the radiation source 12 have dependency on the position of the angle of the X-rays relative to the direction of travel of an electron beam E at the time of a collision with a laser beam L. As the angle of X-rays relative to the direction of travel of an electron beam E at the time of a collision with a laser beam L increases, the energy of the X-rays decreases. As shown in FIG. 7, the energy of X-rays decreases such that the degree of decrease in energy is high as the angle of the X-rays relative to the direction of travel of the electron beam E increases and also as the distance of the X-rays from the center that is the direction of travel of an electron beam E at the time of a collision with a laser beam L increases. Also, in a comparison between high and low energy X-rays, the decrease in energy was greater in high energy X-rays.

In a radiographic image, as the energy of X-rays decreases, the contrast between soft tissue and bone increases. The difference in X-ray energy between a radiographic image captured with high energy X-rays of and one captured with low energy X-rays decreases as the distance of X-rays from the center of the area of the X-ray emission area increases.

For this reason, in the present embodiment, the ratio of the coefficient Ka to the coefficient Kb gradually decreases as the distance of X-rays from the center of the area of X-ray emission increases. Thereby, the value of the ratio of the coefficient Ka to the coefficient Kb is made to fall within a circular coefficient distribution around the center of the X-rays. It is preferable that decreases in ratio of the coefficient Ka to the coefficient Kb correspond to changes in high and low energy X-rays. For example, as the angle of X-rays relative to the direction of travel of an electron beam increases, the greater the decrease in energy. In addition, the coefficient Kc changes so that the image densities are identical.

As described above, by performing subtraction image processing with changed values for the coefficients Ka, Kb, and Kc depending on the position of the center of X-rays emitted, a more satisfactory image of soft tissue can be obtained as compared to the case in which the coefficients Ka, Kb, and Kc are fixed.

Subsequently, in step S24, image information regarding an energy subtraction image obtained by a subtraction image processing is stored in the HDD 110, and the process ends.

As described above, in the present embodiment, pixels corresponding to a radiographic image captured with high energy radiation and pixels corresponding to one captured with low energy radiation are each weighted according to the distance of the X-rays from the center of the area irradiated by the radiation source 12. Then, a weighting calculation is performed such that weighting of a radiographic image captured with high energy radiation is reduced, and a radiographic image captured with low energy radiation is subtracted from the radiographic image captured with high energy radiation. Thereby an image of soft tissue is formed as an energy subtraction image. Accordingly, satisfactory images of soft tissue can be obtained even where the radiation source for emitting radiation using inverse Compton scattering is used.

Although the invention has been described using the foregoing embodiment, it is to be understood that the technical scope of the invention is not limited to the scope described in the foregoing embodiment. Various changes and modifications may be made to the foregoing embodiment without departing from the scope of the invention, and any forms thus changed or modified are included in the technical scope of the invention.

For example, in the foregoing embodiment, a description was given of the case in which images of soft tissue are formed as energy subtraction images. However, the invention is not limited thereto. For example, to form a hard-part image of hard tissue, such as bone, as an energy subtraction image, image processing in which a weighting addition as expressed below by equation (2) is performed such that the ratio of the coefficient Ka to the coefficient Kb gradually decreases as the distance of X-rays from the center of the area of X-ray emission increases, and the value of the ratio of the coefficient Ka and the coefficient Ka falls within a circular coefficient distribution around the center of the X-rays. Furthermore, the coefficient Kc also changes, so that image densities are identical.

N=−Ka×H+Kb×L+Kc (2)

Additionally, in the foregoing embodiment, a description was given of the case in which an imaging stand 16 is constructed such that a radiographic image is captured in a standing posture. However, the invention is not limited thereto. For example, a radiographic image may be captured in a lying position.

In the foregoing embodiment, a description was given of the case in which imaging is carried out by irradiating high energy radiation and low energy radiation, each once, onto the same site to be imaged, and the image processing for forming an energy subtraction image is performed for a captured radiographic image. However, since the range in which radiation is emitted from the radiation source 12 is limited to the rectangular area N, as shown in FIG. 4, when the site to be imaged is large, the energy subtraction image that can be obtained is limited to a partial energy subtraction. This drawback may be overcome, for example, by capturing a high energy radiographic image and a low energy radiographic image by moving the radiation source 12 by use of a support base 52 (serving as a moving section) such that the X-ray emission range for the site to be imaged is changed, then performing image processing in the console 18 where the energy subtraction image for the high energy radiographic image and the energy subtraction image for the low energy radiographic image, both of which have been captured in the corresponding emission ranges, and then performing image processing where the energy subtraction images formed by the corresponding image processing are combined. This makes it possible to obtain an energy subtraction image for the entire site to be imaged even where the site to be imaged is large.

Additionally, in the foregoing embodiment, a description was given of the case in which the radiation source 12 of the radiation generator 14 and the imaging section 54 of the imaging stand 16 are vertically movable. However, the invention is not limited thereto. For example, the radiation source 12 and imaging section 54 may be fixed to make their position relative to each other invariable. In this case, the X-ray emission range and the center of the area of the highest energy X-ray emission within this emission range can be fixed.

Although a description was given of the case in which in the radiation generator 14 the imaging stand 16 is able to move the radiation source 12 in a vertical direction, this stand 16 may be able to move the radiation source 12 in a horizontal direction, too. In this case, the relations between the vertical position of the imaging section 54, the vertical and horizontal positions of the radiation source 12, the X-ray emission range on the imaging surface 56 of the imaging section 54, and the center of the emission range in which the highest energy X-rays are emitted in the direction of travel of the electron beam E at the time of collision with a laser beam L may be stored in advance in the HDD 110, as emitting range information. Then, based on this emission range information stored in the HDD 110, the X-ray emission range on the imaging surface 56 of the imaging section 54 and the center of the area of X-ray emission may be specified by the console 18 from the vertical position of the imaging section 54 and the vertical and horizontal positions of the radiation source 12.

In the foregoing embodiment, a description was given of the case in which the imaging system is configured to include the radiation generator 14, imaging stand 16, and console 18, which are separate devices. However, the invention is not limited thereto. For example, radiographic imaging apparatus may be realized in which the functions of the radiation generator 14, imaging stand 16, and console 18 are integrated in one device.

In the foregoing embodiment, a description was given of the case in which the console 18 performs a subtraction image processing. However, the invention is not limited thereto. For example, a radiographic image captured with high energy radiation and a radiographic image captured with low energy radiation may be transmitted to an image processing device, such as a personal computer, via a network or recording medium, and the subtraction image processing may be performed in this image processing device. In this case, a reading device for reading the interface portion of the network and the recording medium corresponds to the capturing section.

Additionally, needless to say, it should be understood that the configurations described in the foregoing embodiment are examples and that removal of superfluous portions, addition of portions, or changes to connection conditions and so on may be made without departing from the spirit of the invention.

Needless to say, it should be understood that the flow of the imaging control processing program described in the foregoing embodiment is an example and that removal of superfluous steps, addition of steps, or changes in processing order may be made without departing from the spirit of the invention.

What is claimed is:

1. A radiographic imaging apparatus comprising:
a radiation source configured to separately emit high energy radiation and low energy radiation by virtue of inverse Compton scattering;
an imaging section configured to separately capture a radiographic image with the high energy radiation and a radiographic image with the low energy radiation that are emitted from the radiation source onto a same site to be imaged; and
an image processing section configured to perform image processing in which an energy subtraction image is produced by performing a weighting calculation such that the radiographic image captured with the high energy radiation and the radiographic image captured with the low energy radiation by the imaging section are weighted for corresponding pixels according to a distance from a center of the radiation emitted from the radiation source.

2. The radiographic imaging apparatus according to claim 1, wherein when producing a soft part image as the energy subtraction image, the image processing section performs the weighting calculation such that weighting of the radiographic image captured with the high energy radiation is reduced relative to the radiographic image captured with the low energy radiation as the distance from the center increases, and subtracts the radiographic image captured with the low energy radiation from the radiographic image captured with the high energy radiation.

3. The radiographic imaging apparatus according to claim 1, wherein when producing a hard part image as the energy subtraction image, the image processing section performs the weighting calculation such that weighting of the radiographic image captured with the high energy radiation is reduced relative to the radiographic image captured with the low energy radiation as the distance from the center increases, and subtracts the radiographic image captured with the high energy radiation from the radiographic image captured with the low energy radiation.

4. The radiographic imaging apparatus according to claim 1, further comprising a moving section configured to move the radiation source relative to the site to be imaged,
wherein the imaging section separately captures the radiographic image with the high energy radiation and the radiographic image with the low energy radiation while the moving section changes an emission range of the radiation emitted from the radiation source to the site to be imaged, and
wherein the image processing section separately performs the image processing for each of the radiographic image captured with the high energy radiation and the radiographic image captured with low energy radiation in the corresponding radiation ranges by the imaging section, and combines the energy subtraction images produced by each of the image processing.

5. A radiographic imaging system comprising:
a radiation source configured to separately emit high energy radiation and low energy radiation by virtue of inverse Compton scattering;
an imaging section configured to separately capture a radiographic image with the high energy radiation and a radiographic image with the low energy radiation that are emitted from the radiation source onto a same site to be imaged; and
an image processing section configured to perform image processing in which an energy subtraction image is produced by performing a weighting calculation such that the radiographic image captured with the high energy radiation and the radiographic image captured with the low energy radiation by the imaging section are weighted for corresponding pixels according to a distance from a center of the radiation emitted from the radiation source.

6. An image processing device comprising:
a capturing section configured to capture a radiographic image with high energy radiation and a radiographic image with low energy radiation by irradiating a same site to be imaged using a radiation source configured to separately emit high energy radiation and low energy radiation by virtue of inverse Compton scattering; and
an image processing section configured to perform image processing in which an energy subtraction image is produced by performing a weighting calculation such that the radiographic image captured with the high energy radiation and the radiographic image captured with the low energy radiation that are obtained by the capturing section are weighted for corresponding pixels according to a distance from a center of the radiation emitted from the radiation source.

7. A computer-readable recording medium for storing a program to cause a computer to function as an image processing section configured to perform image processing in which an energy subtraction image is produced by performing a weighting calculation such that a radiographic image captured with high energy radiation and a radiographic image captured with low energy radiation by irradiating a same site to be imaged using a radiation source configured to separately emit high energy radiation and low energy radiation by virtue of inverse Compton scattering are weighted for corresponding pixels according to a distance from a center of the radiation emitted from the radiation source.
